(19) United States
(12) Patent Application Publication
(10) Pub. No.: US 2025/0198568 A1
(43) Pub. Date: Jun. 19, 2025

(54) SYSTEM AND METHOD FOR VACUUM INSULATED AND SUSPENDED LIQUID HYDROGEN STORAGE

(71) Applicant: PRELOAD CRYOGENICS, LLC, Quincy, MA (US)

(72) Inventor: Sanjay Mehta, Hauppauge, NY (US)

(21) Appl. No.: 18/969,466

(22) Filed: Dec. 5, 2024

Related U.S. Application Data
(60) Provisional application No. 63/611,523, filed on Dec. 18, 2023.

(51) Int. Cl. F17C 3/08; F17C 6/00

(52) U.S. Cl. CPC F17C 3/08; F17C 6/00; F17C 2201/0109; F17C 2201/032; F17C 2203/0391; F17C 2203/0604; F17C 2203/0629; F17C 2203/0639; F17C 2203/066; F17C 2203/0678; F17C 2205/018; F17C 2205/0352; F17C 2221/012; F17C 2223/0161; F17C 2227/0135; F17C 2250/03; F17C 2250/043; F17C 2250/0626

(57) ABSTRACT

A liquid hydrogen storage system is provided which includes a concrete outer vessel and a steel inner vessel suspended within the outer vessel to create an annular space therebetween. The inner vessel may be suspended using a suspender and include a lateral support strap and a prop coupling the inner vessel to the outer concrete vessel. A vacuum pump may be configured to generate a vacuum in the annular space and a monitoring device may be configured to monitor the pressure within the annular space. A hydrogen removal pump may be configured to remove hydrogen buildup from the annular space. A skirt wall may be coupled to a concrete footing, a seismic strap coupled to the outer vessel and the skirt wall, and a slide bearing positioned between the outer vessel and the skirt wall for stability. Methods of storing liquid hydrogen are also provided.

### CROSS REFERENCE TO RELATED APPLICATIONS

This application claims the benefit of U.S. Provisional Application Ser. No. 63/611,523, filed on Dec. 18, 2023. The entire disclosure of the above application is incorporated herein by reference.

### FIELD

The present technology relates to liquid hydrogen storage systems and, more particularly, suspended/propped, vacuum insulated liquid hydrogen storage.

### INTRODUCTION

This section provides background information related to the present disclosure which is not necessarily prior art.

Hydrogen is a versatile and environmentally friendly energy carrier, widely recognized for its potential in clean energy applications. When used as a fuel, hydrogen produces zero carbon emissions, making it a promising alternative to fossil fuels in sectors such as transportation, power generation, manufacturing. Among the various forms of hydrogen storage, liquid hydrogen has garnered significant attention due to its high energy density and suitability for large-scale applications, including use in fuel cell vehicles, aerospace applications, and energy storage systems.

Storing hydrogen in its liquid state, however, can be challenging due to its physical properties. Cryogenic storage of hydrogen can include liquid temperatures of −423° F. (−250° C.). Liquid hydrogen requires complex storage systems that can maintain very low temperatures while also safely containing hydrogen. Liquid hydrogen storage vessels can include double walled tanks surrounded by insulation inside an outer structure to prevent heat transfer, minimize boil off losses, and ensure structural integrity under such demanding conditions. Proper thermal performance and structural integrity of such storage systems are important considerations in design of long-term hydrogen containment systems.

Hydrogen storage systems can also take into account hydrogen's small molecular size, as hydrogen may diffuse through certain materials, requiring advanced material solutions and robust containment methods. Hydrogen buildup in portions of a storage system can occur due to hydrogen atoms/molecules permeating through a vessel wall or from hydrogen boil-off during storage. Without proper removal of hydrogen buildup, hydrogen atoms/molecules penetrating a vessel wall structure can cause hydrogen embrittlement and cracking of certain materials, such as steel. Storage systems used for liquid hydrogen storage that nest inner containers within outer steel or pressurized concrete containers may not address the issue of hydrogen buildup because, unlike inner containers that may use materials known to resist hydrogen permeation and embrittlement, the outer containers are not constructed from such material.

There are other considerations in the construction of a hydrogen storage system. The hydrogen storage system can be exposed to external hazards such as weather, fire, impact, seismic activity, etc. The hydrogen storage system should also take into account the issue of thermal expansion and contraction between components, such as an outer container and an inner container. Thermal changes can lead to stress and strain on the vessel and its supporting structures, potentially compromising storage effectiveness over time. Rapid pressure changes and/or structural breaches can result in significant losses of hydrogen through vaporization and diffusion, complicating containment. Storage systems can be equipped with one or more pressure relief valves and venting systems to manage internal pressure. Components such as flexible supports can be used but can add complexity and cost to hydrogen storage system designs. Due to such challenges, hydrogen storage systems face certain limitations in terms of integrity requirements and container design.

Accordingly, there is a continuing need for an enhanced vacuum-insulated liquid hydrogen storage system that efficiently prevents hydrogen leakage and ensures long term structural integrity in the face of seismic events.

### SUMMARY

In accordance with the instant disclosure, an enhanced vacuum-insulated liquid hydrogen storage system that efficiently prevents hydrogen leakage and ensures long term structural integrity in the face of seismic events, has surprisingly been discovered. The present technology includes systems and processes that relate to a vacuum insulated and suspended liquid hydrogen storage system.

In certain embodiments, a liquid hydrogen storage system is provided. The liquid hydrogen storage system may include an outer vessel where a portion of outer vessel is made of concrete. The outer vessel may be made of prestressed concrete to provide the required strength to resist high compressive stresses. The outer vessel may include an outer surface, and steel liner may be disposed on the outer surface of the outer vessel as a moisture barrier. Alternatively, an epoxy coating may be coated on an inner surface of the outer vessel to prevent moisture transfer. The liquid hydrogen storage system may include an inner vessel where a portion of the inner vessel is made of steel. The inner vessel may be configured to contain liquid hydrogen. The inner vessel may be suspended within the outer vessel to create an annular space between the inner vessel and the outer vessel. The liquid hydrogen storage system may also include a vacuum pump that is fluidly coupled to the annular space. The vacuum pump may be configured to maintain a predetermined pressure within the annular space when the inner vessel contains liquid hydrogen.

In certain embodiments, the liquid hydrogen storage system may include a monitoring device. The monitoring device may be configured to monitor a vacuum within the annular space. The monitoring device may be in the form of a pressure gauge. The liquid hydrogen storage system may also include a controller in communication with the vacuum pump and the monitoring device. The controller may be further configured to actuate the vacuum pump when the vacuum within the annular space is not at a predetermined pressure. The controller may then operate the vacuum pump to the predetermined pressure level. The liquid hydrogen storage system may also include a hydrogen removal pump. The hydrogen removal pump may be fluidly coupled to the annular space. The hydrogen removal pump may be further configured to remove hydrogen from the annular space to significantly reduce hydrogen gas permeation through outer concrete wall and mitigate against hydrogen embrittlement. In other embodiments, the vacuum pump may be further configured to remove hydrogen from the annular space.

In certain embodiments, the liquid hydrogen storage system may include a fill line. the fill line may be coupled to each of the outer vessel and the inner vessel. The fill line may be in fluid communication with the inner vessel and configured to transport liquid hydrogen to the inner vessel. The liquid hydrogen storage system may also include a drawdown line. The drawdown line may be coupled to each of the inner vessel and the outer vessel. The drawdown line may be in fluid communication with the inner vessel and may be configured to remove hydrogen from the inner vessel.

The liquid hydrogen storage system may also include support structures such as one or more suspenders. Each suspender may be coupled to each of the inner vessel and the outer vessel. The liquid hydrogen storage system may also include one or more lateral support straps. Each lateral support strap may be coupled to each of inner vessel and the outer vessel. The liquid hydrogen storage system may also include one or more props. Each prop may be coupled to each of the inner vessel and the outer vessel. Within the annular space between the inner vessel and outer vessel, the liquid hydrogen storage system may include insulation material disposed within the annular space. The insulation material may include glass bead insulation or perlite powder. The liquid hydrogen storage system may combine insulation material and a vacuum in the annular space to further improve the efficiency of the insulation in the annular space.

In certain embodiments, the liquid hydrogen storage system may include a concrete footing. The concrete footing may include a top surface positioned under the outer vessel. The liquid hydrogen storage system may also include a skirt wall disposed on the top surface of the concrete footing. The skirt wall may be configured to surround a portion of the outer vessel. The liquid hydrogen storage system may also include one or more seismic straps. Each seismic strap may be coupled to each of the skirt wall and the outer vessel. In some embodiments, the liquid hydrogen storage system may include a slide bearing positioned between the outer vessel and the skirt wall. The slide bearing may have a portion made of neoprene. The slide bearing may provide free sliding and separation of the outer vessel from the skirt wall.

Various ways of assembling the liquid hydrogen storage system are provided. Certain methods may include the step of providing an outer vessel, an inner vessel, and a vacuum pump. A portion of the outer vessel may include concrete. A portion of the inner vessel may include steel. The inner vessel may be configured to contain liquid hydrogen. The method may include a step of suspending the inner vessel within the outer vessel to form an annular space. The method may include the step of fluidly coupling the vacuum pump to the annular space. The vacuum pump may be configured to maintain a predetermined pressure within the annular space. The method may include the step of maintaining a predetermined pressure within the annular space via vacuum pump when the inner vessel contains the liquid hydrogen. Finally, the method may include the step of receiving liquid hydrogen within the inner vessel.

In certain embodiments, a method of storing liquid hydrogen may include a step of providing an outer vessel, an inner vessel, a vacuum pump, a monitoring device, and a hydrogen removal pump. A portion of the outer vessel may include concrete. A portion of the inner vessel may include steel. The vacuum pump may be configured to maintain a predetermined pressure within an annular space. The inner vessel may be configured to contain liquid hydrogen. The monitoring device may be configured to monitor a pressure within the annular space. The hydrogen removal pump may be configured to remove hydrogen gas from the annular space. The method may include a step of suspending the inner vessel within the outer vessel to form an annular space. The method may include the step of fluidly coupling the vacuum pump to the annular space. The method may include the step of receiving liquid hydrogen within the inner vessel. The method may include the step of maintaining a predetermined pressure within the annular space via vacuum pump when the inner vessel contains the liquid hydrogen. The method may include the step of monitoring the pressure within the annular space with the monitoring device. Finally, the method may also include the step of removing hydrogen gas from the annular space with the hydrogen removal pump.

In certain embodiments, a method of storing liquid hydrogen may include the step of providing an outer vessel, an inner vessel, a vacuum pump, a skirt wall, a suspender, a seismic strap, and a slide bearing. A portion of the outer vessel may include concrete. A portion of the inner vessel may include steel. The inner vessel may be configured to contain liquid hydrogen. The skirt wall may be configured to surround a portion of the outer vessel. The method may include a step of suspending the inner vessel within the outer vessel to form an annular space. The method may include the step of fluidly coupling the vacuum pump to the annular space. The vacuum pump may be configured to maintain a predetermined pressure within the annular space. The method may include the step of maintaining a predetermined pressure within the annular space via vacuum pump when the inner vessel contains the liquid hydrogen. The method may include the step of receiving liquid hydrogen within the inner vessel. The method may further include the step of positioning the skirt wall around a portion of the outer vessel. The method may include the step of coupling the suspender to each of the inner vessel and outer vessel. The method may include the step of coupling the seismic strap to the skirt wall. The method may also include the step of coupling the seismic strap to the outer vessel. Finally, the method may include the step of positioning the slide bearing between the outer vessel and the skirt wall.

Advantageously, the liquid hydrogen storage system provides an enhanced vacuum-insulated hydrogen storage system that efficiently prevents hydrogen leakage and ensures long term structural integrity in the face of seismic events. Suspending the inner vessel within the outer vessel with a suspender enhances the protection of the liquid hydrogen storage system from seismic waves propagating through the ground and through the concrete footing and wall skirt. The seismic strap and slide bearing allow the liquid hydrogen storage system to freely rest within the skirt wall, providing flexibility in movement without a loss of structural integrity. Additionally, the vacuum pump provides additional protection against a loss of structural integrity by mitigating boil-off-gas and maintaining insulation within the annular space.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram illustrating a liquid hydrogen storage system, according to an embodiment of the present disclosure;

FIG. 2 is a cross-sectional view of the liquid hydrogen storage system according to another embodiment of the present disclosure;

FIG. 3 is a top cross-sectional view of the liquid hydrogen storage system according to the embodiment of FIG. 2;

FIG. 4 is a cross-sectional view of the liquid hydrogen storage system according to the embodiment of FIG. 2;

FIG. 5 is a flowchart illustrating a method for storing liquid hydrogen, according to the embodiment of FIG. 2;

FIG. 6 is a flowchart illustrating a method for storing liquid hydrogen, according to another embodiment of the present disclosure; and

FIG. 7 is a flowchart illustrating a method for storing liquid hydrogen, according to another embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

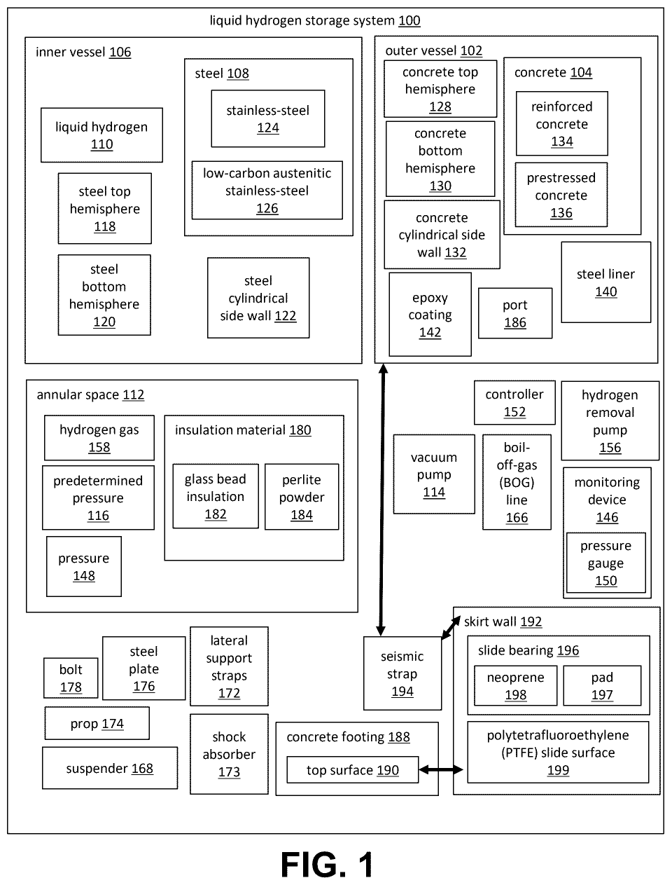

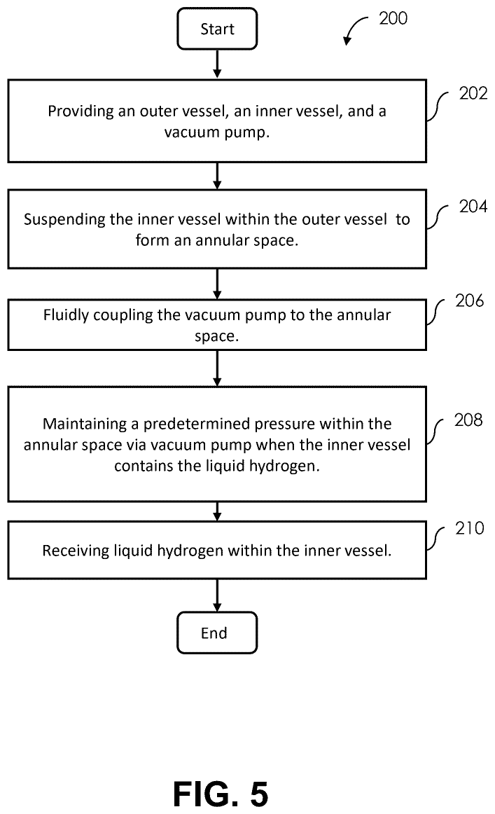

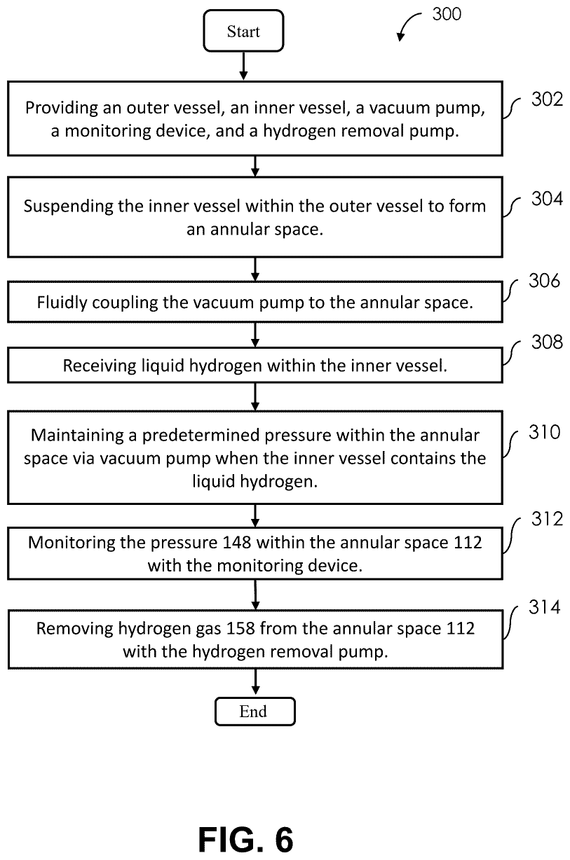

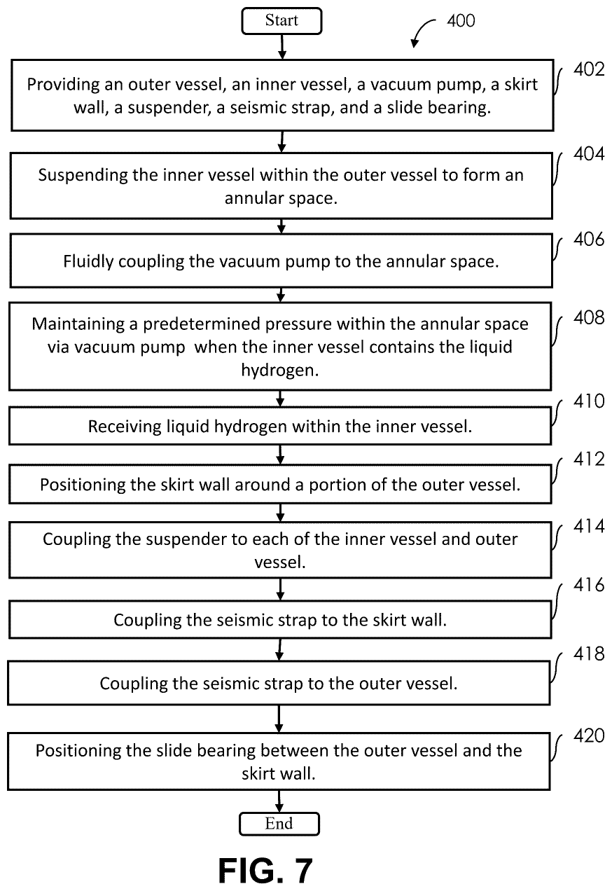

The present technology relates to a liquid hydrogen storage system 100, aspects of which are shown in FIGS. 1 through 4. Advantageously, the liquid hydrogen storage system 100 provides an enhanced vacuum-insulation that efficiently prevents hydrogen leakage and ensures long term structural integrity. A method 200 of storing liquid hydrogen 110 using such a liquid hydrogen storage system 100 is provided in FIG. 5. Another method 300 of storing liquid hydrogen 110 is provided in FIG. 6. And yet another method 400 of storing liquid hydrogen 110 is provided in FIG. 7.

As shown in FIGS. 1 through 4, certain aspects of a liquid hydrogen storage system 100 are illustrated. The liquid hydrogen storage system 100 may include an outer vessel 102 where a portion of the outer vessel 102 includes concrete 104. The outer vessel 102 may be made of prestressed concrete 136 or reinforced concrete 134 to provide the required strength to resist high compressive stresses. The liquid hydrogen storage system 100 may include an inner vessel 106 where a portion of the inner vessel 106 includes steel 108. The inner vessel 106 may be configured to contain liquid hydrogen 110. The inner vessel 106 may be suspended within the outer vessel 102 to create an annular space 112 between the inner vessel 106 and the outer vessel 102. The liquid hydrogen storage system 100 may also include a vacuum pump 114 that is fluidly coupled to the annular space 112. The vacuum pump 114 may be configured to maintain a predetermined pressure 116 (e.g., a pressure lower than adjacent pressure, including adjacent vessel pressures as well as ambient atmospheric pressure, creating a vacuum) within the annular space 112 when the inner vessel 106 contains liquid hydrogen 110.

The inner vessel 106 may include the following aspects. The inner vessel 106 may include a steel top hemisphere 118 and a steel bottom hemisphere 120. The inner vessel 106 may also include a steel cylindrical side wall 122. The inner vessel 106 may be made of materials including stainless-steel 124 and low-carbon austenitic stainless-steel 126. The inner vessel 106 may be configured to contain a quantity of liquid hydrogen 110. For example, the liquid hydrogen storage system 100 may store up to 24,000 kilograms of liquid hydrogen 110. The inner vessel 106 may be positioned upright with the steel top hemisphere 118, steel cylindrical side wall 122, and steel bottom hemisphere 120 aligned vertically. In one example, the inner vessel 106 may have a height between 20 and 40 ft, and a width between 10 and 30 ft. It should be appreciated that one skilled in the art may construct or use a liquid hydrogen storage system 100 with dimensions differing from these examples, as desired.

The outer vessel 102 may include the following aspects. The outer vessel 102 may include a concrete top hemisphere 128 and a concrete bottom hemisphere 130. The outer vessel 102 may also include a concrete cylindrical side wall 132. The concrete top hemisphere 128, concrete cylindrical side wall 132, and concrete bottom hemisphere 130 may each include a thickness between 6 and 18 inches. As an example, the concrete top hemisphere 128, concrete cylindrical side wall 132, and concrete bottom hemisphere 130 of the outer vessel 102 may include 12-inch-thick reinforced concrete 134. As another example, the concrete top hemisphere 128, concrete cylindrical side wall 132, and concrete bottom hemisphere 130 of the outer vessel 102 may include 12-inch-thick prestressed concrete 136. One of ordinary skill in the art may select a suitable configuration for the outer vessel 102 within the scope of the present disclosure. The outer vessel 102 may include an outer surface 138, and a steel liner 140 may be disposed on the outer surface 138 of the outer vessel 102 as a barrier for air and moisture. The steel liner 140 may include a thickness between 1/16 and 5/16 inch. An epoxy coating 142 may be coated on an inner surface 144 of the outer vessel 102 to prevent moisture transfer. Alternatively, an outer vessel 102 may include both an epoxy coating 142 on the inner surface 144 as a moisture barrier and a steel liner 140 on the outer surface 138, as desired. The outer vessel 102 may be positioned upright with the concrete top hemisphere 128, concrete cylindrical side wall 132, and concrete bottom hemisphere 130 aligned vertically. In one example, the outer vessel 102 may have a height between 25 and 50 ft, and a width between 20 and 40 ft. It should be appreciated that one skilled in the art may construct or use a liquid hydrogen storage system 100 with dimensions differing from the example above, as desired.

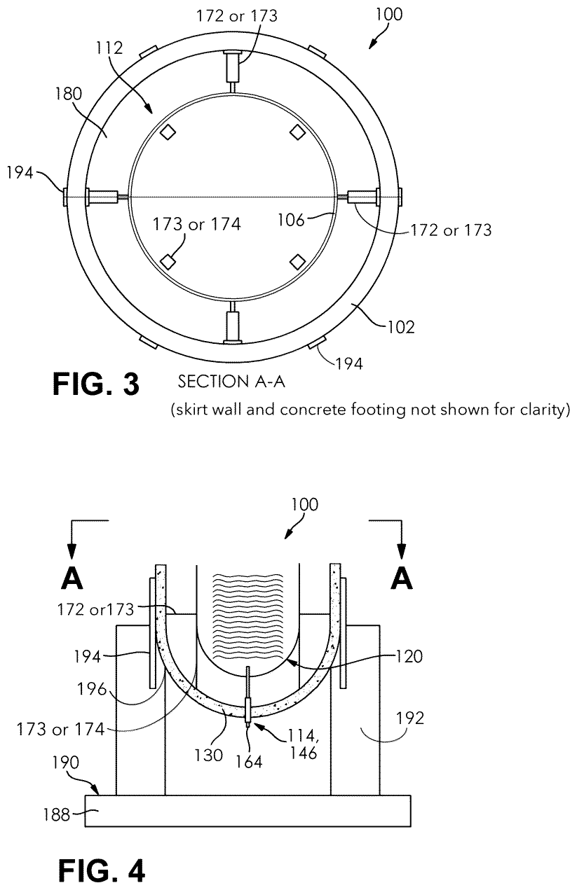

The liquid hydrogen storage system 100 may include a monitoring device 146, as shown in FIG. 1. The monitoring device 146 may be configured to monitor a pressure 148 (e.g., maintenance of a pressure lower than adjacent pressure, including adjacent vessel pressures as well as ambient atmospheric pressure) within the annular space 112. The monitoring device 146 may be in the form of a pressure gauge 150. The liquid hydrogen storage system 100 may also include a controller 152 in communication with the vacuum pump 114 and the monitoring device 146. The controller 152 may be further configured to actuate the vacuum pump 114 when the pressure 148 within the annular space 112 is not at a predetermined pressure 116. The controller 152 may then operate the vacuum pump 114 to the predetermined pressure 116 level and may actuate the vacuum pump 114 to remove air that could penetrate the outer vessel 102 from outside the liquid hydrogen storage system 100. The liquid hydrogen storage system 100 may also include a hydrogen removal pump 156 (some hydrogen gas molecules could pass through the inner vessel into the annular space). The hydrogen removal pump 156 may be fluidly coupled to the annular space 112. The hydrogen removal pump 156 may be further configured to remove hydrogen gas 158 from the annular space 112 to significantly reduce hydrogen gas 158 permeation through the outer vessel 102 and mitigate against hydrogen embrittlement, as shown in FIG. 3. The vacuum pump 114 may be further configured to remove hydrogen gas 158 from the annular space 112. The liquid hydrogen storage system 100 may also include a boil-off gas (BOG) line 166 to allow hydrogen gas 158 to be removed from the liquid hydrogen storage system 100. The BOG line 166 may be coupled to the hydrogen removal pump 156 to remove hydrogen gas 158 from the annular space 112. Alternatively, the BOG line 166 may be coupled to the vacuum pump 114 to remove hydrogen gas 158 from the annular space 112.

The liquid hydrogen storage system 100 may include a fill line 162. The fill line 162 may be coupled to each of the outer vessel 102 and the inner vessel 106. The fill line 162 may be in fluid communication with the inner vessel 106 and configured to transport liquid hydrogen 110 to the inner vessel 106. The liquid hydrogen storage system 100 may also include a drawdown line 164. The drawdown line 164 may be coupled to each of the inner vessel 106 and the outer vessel 102. The drawdown line 164 may be in fluid communication with the inner vessel 106 and may be configured to remove liquid hydrogen 110 from the inner vessel 106.

As shown in FIGS. 1, 2 and 3, the liquid hydrogen storage system 100 may include support structures such as one or more suspenders 168. Each suspender 168 may be coupled to both the inner vessel 106 and the outer vessel 102. The liquid hydrogen storage system 100 may also include one or more lateral support straps 172. Each lateral support strap 172 may be coupled to both the inner vessel 106 and the outer vessel 102. The liquid hydrogen storage system 100 may also include one or more shock absorbers 173, each coupled to both the inner vessel 106 and the outer vessel 102, in lieu of lateral straps 172 or props 174. The liquid hydrogen storage system 100 may also include one or more props 174, each coupled to both the inner vessel 106 and the outer vessel 102. The suspender 168, lateral support strap 172, and/or prop 174 may be made of steel 108. The suspender 168, lateral support strap 172, and/or prop 174 may be supported on the outer vessel 102 with cast-in-place concrete 104 after the concrete 104 has cured. Additionally, the suspender 168, lateral support strap 172, and/or prop 174 may be coupled to the outer vessel 102 by a steel plate 176 and a bolt 178. The prop 174 may be coupled to both the inner vessel 106 and the outer vessel 102 at an outward angle to facilitate the lack of pressure within the annular space 112.

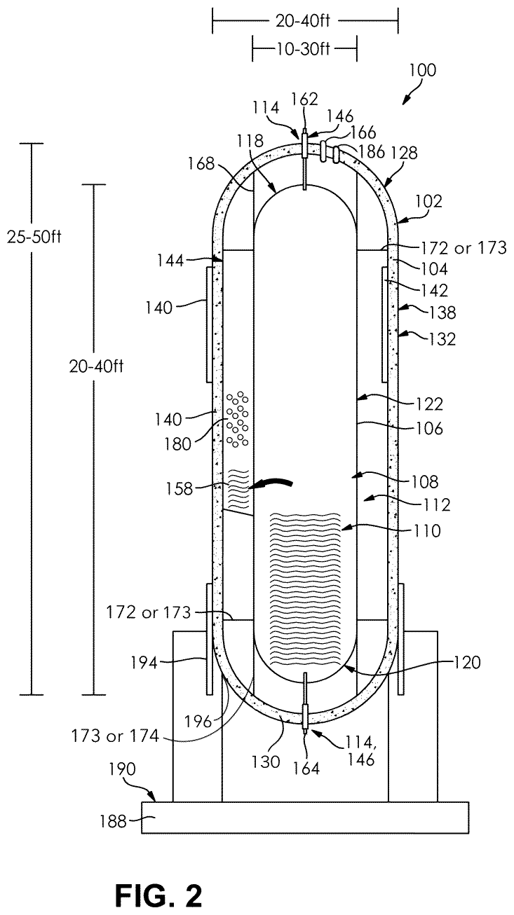

As shown in FIG. 2, the liquid hydrogen storage system 100 may include insulation material 180 disposed within the annular space 112. The insulation material 180 may include glass bead insulation 182 and/or perlite powder 184. The liquid hydrogen storage system 100 may combine insulation material 180 and a predetermined pressure 116 in the annular space 112 to further improve the efficiency of the insulation in the annular space 112. The liquid hydrogen storage system 100 may also include a port 186 disposed on the outer vessel 102 to fill the annular space 112 with insulation material 180.

The base structure of the liquid hydrogen storage system 100 may include the following aspects. As shown in FIGS. 1 and 4, the liquid hydrogen storage system 100 may include a concrete footing 188. The concrete footing 188 may include a top surface 190 positioned under the outer vessel 102. The liquid hydrogen storage system 100 may also include a skirt wall 192 disposed on the top surface 190 of the concrete footing 188, as shown in FIG. 4. The skirt wall 192 may be configured to surround a portion of the outer vessel 102. The liquid hydrogen storage system 100 may also include a seismic strap 194, as shown in FIGS. 2-4. The seismic strap 194 may be coupled to each of the skirt wall 192 and the outer vessel 102. The liquid hydrogen storage system 100 may include one or more slide bearings 196 positioned between the outer vessel 102 and the skirt wall 192. The slide bearing 196 may have a portion made of neoprene 198. The neoprene 198 may be in the form of a pad 197 and may have a thickness between ½ and 1½ inch, to provide extra support for the surface contact between the outer vessel 102 and the skirt wall 192. Alternatively, the liquid hydrogen storage system 100 may use a polytetrafluoroethylene (PTFE) slide surface 199 instead of the slide bearing 196. The slide bearing 196 may provide free sliding and separation of the outer vessel 102 from the skirt wall 192. The seismic strap 194 may be coupled to the outer vessel 102 so that the seismic strap 194 provides flexible stability for the outer vessel 102, where the seismic strap 194 only tightens when the outer vessel 102 shifts or rotates against the slide bearings 196.

As shown in FIG. 5, a method 200 of storing liquid hydrogen 110 is provided. The method 200 may include a step 202 of providing an outer vessel 102, an inner vessel 106, and a vacuum pump 114. A portion of the outer vessel 102 may include concrete 104. A portion of the inner vessel 106 may include steel 108. The inner vessel 106 may be configured to contain liquid hydrogen 110. The method 200 may include a step 204 of suspending the inner vessel 106 within the outer vessel 102 to form an annular space 112. The method 200 may include the step 206 of fluidly coupling the vacuum pump 114 to the annular space 112. The vacuum pump 114 may be configured to maintain a predetermined pressure 116 within the annular space 112. The method 200 may include the step 208 of maintaining a predetermined pressure 116 within the annular space 112 via vacuum pump 114 when the inner vessel 106 contains the liquid hydrogen 110. Finally, the method 200 may include the step 210 of receiving liquid hydrogen 110 within the inner vessel 106.

As shown in FIG. 6, a method 300 of storing liquid hydrogen 110 is provided. The method 300 may include a step 302 of providing an outer vessel 102, an inner vessel 106, a vacuum pump 114, a monitoring device 146, and a hydrogen removal pump 156. A portion of the outer vessel 102 may include concrete 104. A portion of the inner vessel 106 may include steel 108. The vacuum pump 114 may be configured to maintain a predetermined pressure 116 within an annular space 112. The inner vessel 106 may be configured to contain liquid hydrogen 110. The monitoring device 146 may be configured to monitor a pressure 148 within the annular space 112. The hydrogen removal pump 156 may be configured to remove hydrogen gas 158 from the annular space 112. The method 300 may include a step 304 of suspending the inner vessel 106 within the outer vessel 102 to form an annular space 112. The method 300 may include the step 306 of fluidly coupling the vacuum pump 114 to the annular space 112. The method 300 may include the step 308 of receiving liquid hydrogen 110 within the inner vessel 106. The method 300 may include the step 310 of maintaining a predetermined pressure 116 within the annular space 112 via vacuum pump 114 when the inner vessel 106 contains the liquid hydrogen 110. The method 300 may include the step 312 of monitoring the pressure 148 within the annular space 112 with the monitoring device 146. Finally, the method 300 may also include the step 314 of removing hydrogen gas 158 from the annular space 112 with the hydrogen removal pump 156.

As shown in FIG. 7, a method 400 of storing liquid hydrogen 110 is provided. The method 400 may include a step 402 of providing an outer vessel 102, an inner vessel 106, a vacuum pump 114, a skirt wall 192, a suspender 168, a seismic strap 194, and a slide bearing 196. A portion of the outer vessel 102 may include concrete 104. A portion of the inner vessel 106 may include steel 108. The inner vessel 106 may be configured to contain liquid hydrogen 110. The skirt wall 192 may be configured to surround a portion of the outer vessel 102. The method 400 may include a step 404 of suspending the inner vessel 106 within the outer vessel 102 to form an annular space 112. The method 400 may include the step 406 of fluidly coupling the vacuum pump 114 to the annular space 112. The vacuum pump 114 may be configured to maintain a predetermined pressure 116 within the annular space 112. The method 400 may include the step 408 of maintaining a predetermined pressure 116 within the annular space 112 via vacuum pump 114 when the inner vessel 106 contains the liquid hydrogen 110. The method 400 may include the step 410 of receiving liquid hydrogen 110 within the inner vessel 106. The method 400 may further include the step 412 of positioning the skirt wall 192 around a portion of the outer vessel 102. The method 400 may include the step 414 of coupling the suspender 168 to each of the inner vessel 106 and outer vessel 102. The method 400 may include the step 416 of coupling the seismic strap 194 to the skirt wall 192. The method 400 may also include the step 418 of coupling the seismic strap 194 to the outer vessel 102. Finally, the method 400 may include the step 420 of positioning the slide bearing 196 between the outer vessel 102 and the skirt wall 192.

Advantageously, the liquid hydrogen storage system 100 provides an enhanced vacuum-insulated hydrogen storage that efficiently militates effects of hydrogen leakage and ensures long term structural integrity in the face of seismic events. Seismic damage is a significant risk for any large storage facility, especially for cryogenic storage tanks that rely on maintaining an extremely low internal temperature and pressure equilibrium. Suspending the inner vessel 106 within the outer vessel 102 with the suspender 168 enhances the protection of the liquid hydrogen storage system 100 from seismic activity propagating through the ground and through the concrete footing 188 and wall skirt. The seismic protection can further be enhanced by using shock absorbers 173 in lieu of lateral straps 172/props 174, if required. The seismic strap 194 and slide bearing 196 allow the liquid hydrogen storage system 100 to freely rest within the skirt wall 192, providing flexibility in movement without a loss of structural integrity. Additionally, the vacuum pump 114 provides additional protection against a loss of structural integrity by mitigating boil-off-gas and maintaining insulation within the annular space 112. Thus, suspending the inner vessel 106 within the outer vessel 102, allowing the outer vessel 102 to be positioned freely against the slide bearing 196, and maintaining a vacuum within the annular space serves to optimize operation, durability, and stability in the liquid hydrogen storage system 100.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A liquid hydrogen storage system, comprising:
an outer vessel having a portion thereof formed of concrete;
an inner vessel having a portion thereof formed of steel, the inner vessel configured to contain the liquid hydrogen, and the inner vessel suspended within the outer vessel to form an annular space there between; and
a vacuum pump fluidly coupled to the annular space, the vacuum pump configured to maintain a predetermined pressure within the annular space when the inner vessel contains the liquid hydrogen.

2. The liquid hydrogen storage system of claim 1, further comprising a monitoring device configured to monitor a pressure within the annular space.

3. The liquid hydrogen storage system of claim 2, further comprising a controller in communication with the vacuum pump and the monitoring device, the controller configured to actuate the vacuum pump when the pressure within the annular space is not at the predetermined pressure and operate the vacuum pump to return the pressure to the predetermined pressure.

4. The liquid hydrogen storage system of claim 1, including a hydrogen removal pump fluidly coupled to the annular space, the hydrogen removal pump configured to remove hydrogen from the annular space.

5. The liquid hydrogen storage system of claim 1, wherein the vacuum pump is further configured to remove hydrogen from the annular space.

6. The liquid hydrogen storage system of claim 1, the outer vessel including an outer surface and a liner disposed on the outer surface of the outer vessel, the liner having a portion formed of a member selected from the group consisting of a metal coating and an epoxy coating.

7. The liquid hydrogen storage system of claim 1, including a fill line coupled to each of the outer vessel and the inner vessel and in fluid communication with the inner vessel, the fill line configured to transport liquid hydrogen to the inner vessel.

8. The liquid hydrogen storage system of claim 1, including a drawdown line coupled to each of the inner vessel and the outer vessel, and in fluid communication with the inner vessel, the drawdown line configured to remove hydrogen from the inner vessel.

9. The liquid hydrogen storage system of claim 1, further comprising a suspender coupled to each of the inner vessel and the outer vessel.

10. The liquid hydrogen storage system of claim 1, including a lateral support strap coupled to each of the inner vessel and the outer vessel.

11. The liquid hydrogen storage system of claim 1, including a prop coupled to each of the inner vessel and the outer vessel.

12. The liquid hydrogen storage system of claim 1, where the annular space includes an insulation material.

13. The liquid hydrogen storage system of claim 1, including a concrete footing positioned under the outer vessel, the concrete footing having a top surface.

14. The liquid hydrogen storage system of claim 13, including a skirt wall disposed on the top surface of the concrete footing, the skirt wall configured to surround a portion of the outer vessel.

15. The liquid hydrogen storage system of claim 14, including a seismic strap coupled to the skirt wall and coupled to the outer vessel.

16. The liquid hydrogen storage system of claim 14, including a slide bearing positioned between the outer vessel and the skirt wall.

17. A method of storing liquid hydrogen, the method comprising:
providing a liquid hydrogen storage system according to claim 1; and
receiving liquid hydrogen within the inner vessel.

18. The method of claim 17, further comprising:
providing a monitoring device and a hydrogen removal pump;
monitoring the vacuum within the annular space with the monitoring device; and
removing hydrogen from the annular space with the hydrogen removal pump.

19. The method of claim 17, further comprising:
providing a skirt wall, a suspender, a seismic strap, and a slide bearing;
positioning the skirt wall around a portion of the outer vessel;
coupling the suspender to each of the inner vessel and outer vessel;
coupling the seismic strap to the skirt wall;
coupling the seismic strap to the outer vessel; and
positioning the slide bearing between the outer vessel and the skirt wall.

20. A liquid hydrogen storage system, comprising:
an outer vessel having a portion thereof formed of concrete;
an inner vessel having a portion thereof formed of steel, the inner vessel configured to contain the liquid hydrogen, and the inner vessel suspended within the outer vessel to form an annular space therebetween;
a vacuum pump fluidly coupled to the annular space, the vacuum pump configured to maintain a predetermined pressure within the annular space when the inner vessel contains the liquid hydrogen;
a monitoring device configured to monitor a vacuum within the annular space;
a controller in communication with the vacuum pump and the monitoring device, the controller configured to actuate the vacuum pump when the vacuum within the annular space is not at the predetermined pressure and operate the vacuum pump to return the vacuum to the predetermined pressure;
a suspender coupled to each of the inner vessel and the outer vessel;
a hydrogen removal pump fluidly coupled to the annular space, the hydrogen removal pump configured to remove hydrogen from the annular space;
a skirt wall configured to surround a portion of the outer vessel;
a seismic strap coupled each of the skirt wall and the outer vessel; and
a slide bearing positioned between the outer vessel and the skirt wall.
